(19) United States
(12) Patent Application Publication
(10) Pub. No.: US 2014/0037915 A1
(43) Pub. Date: Feb. 6, 2014

(54) MEMBRANES FOR FLEXIBLE MICROBIAL FUEL CELL CATHODES AND OTHER APPLICATIONS

(71) Applicant: E I Du Pont De Nemours and Company, Wilmington, DE (US)

(72) Inventors: Serge Rebouillat, Echenevex (FR); Benyoussef Bisbis, Echternach (LU); Robert D Fallon, Elkton, MD (US); Steven Raymond Lustig, Landenberg, PA (US)

(73) Assignee: E I Du Pont De Nemours and Company, Wilmington, DE (US)

(21) Appl. No.: 13/955,108

(22) Filed: Jul. 31, 2013

Related U.S. Application Data
(60) Provisional application No. 61/677,606, filed on Jul. 31, 2012.

(51) Int. Cl. B32B 7/14; B32B 7/04

(52) U.S. Cl. CPC B32B 7/14; B32B 7/045
USPC 428/198; 428/201

(57) ABSTRACT

A membrane for use as a packaging or in microbial fuel cells having a first layer of a polymer having a high oxygen permeability and a second supporting layer made of a woven or a non-woven material, wherein both layers are dot laminated and/or pattern laminated together by using an adhesive.

### BACKGROUND OF THE INVENTION

1. Field of the Invention

The present invention relates to a membrane for use in a microbial fuel cell.

2. Description of the Related Art

Microbial fuel cells (MFCs) are devices that use bacteria as a catalyst to oxidize organic and inorganic matter and generate electrical current. During the reaction, electrons produced by the bacteria from these substrates flow to the cathode. A new form of waste water treatment plant is being developed using this concept, in which water is purified and electricity is produced as a by-product.

US 2011/0229742 discloses a bacterial fuel cell including a plurality of anodes and a plurality of cathodes in contact with a liquid to be purified. The plurality of anodes and the plurality of cathodes each include a metal electrical conductor arranged to be electrically coupled across a load in an electrical circuit and an electrically conductive coating at least between the metal electrical conductor and the liquid to be purified. The electrically conductive coating operates to mutually seal the liquid and the electrical conductor from each other.

The article “Microbial Fuel Cell Cathodes with Poly(dimethylsiloxane) Diffusion Layers Constructed around Stainless Steel Mesh Current Collectors” (Fang Zhang et al., Environmental Science & Technology, vol. 44, N° 4, 2010, pages 1490-1495, published on Jan. 25, 2010) discloses an approach for making cathodes of microbial fuel cells by using metal mesh current collectors and inexpensive polymer/carbon diffusion layers. In this article, rather than adding a current collector to a cathode material such as carbon cloth, the authors constructed the cathode around a metal mesh itself thereby avoiding the need for carbon cloth or other supporting material.

For such cells to work efficiently, the cathode (in a flexible substrate form), which is an important element in the electron collection process, must have the following characteristics:
allow required amount of oxygen to be available to the bacteria;
have a very low surface electrical resistivity to act as a conductor;
insure water tightness in a durable way.

Those skilled in the art will normally use polymer films that are very open to oxygen, such as polydimethylsiloxanes (PDMS), polyphenyleneoxides (PPO), polymethylpentenes (PMP) and others as illustrated in the article “Permeation of O₂, Ar₂ and N₂ through polymer membranes” (K. Haraya and S. Huang, Journal of Membrane Science, 71 (1992) 13-27). These films are used to separate oxygen from air, and therefore one side is under pressure and the diffusion takes place from the high pressure side to the low pressure side with air/gas on both sides. With MFCs however, the diffusion is taking place from air at atmospheric pressure against water pressure on the other side, where there is an oxygen sink as the bacteria consume it as soon as it gets there.

Another important aspect is the commercial process of enabling production of these membranes. The use of PDMS will usually require a batch process because its room temperature vulcanization (RTV) or even heat activated curing requires at least 15 minutes to complete. During curing, carbon black powder is added to provide electrical conductivity. This eliminates the possibility of producing this membrane in a roll to roll process.

In the prior art, sheets (woven or nonwoven) loaded with carbon black have been widely used in combination with Nafion membranes or have been coated with silicon-based materials (e.g. PDMS: polydimethylsiloxanes). Stainless steel in all forms that provide a surface area (mesh, woven, nonwoven) is also proposed with silicon coating. However, most of these uses are limited to laboratory scale applications so far.

Most of the disadvantages of prior art MFCs have to do with commercial production of above described approaches and especially with the impact on final cost of the electrode. Another shortcoming for this application is that the coating applied to an open structure (woven or nonwoven conductor), is not uniform throughout, leading to the coating penetrating into the voids of the structure. This causes different thicknesses which lead to different local permeability of oxygen. In an industrial installation electrode structures covering a height of between 1 m to 3 m, with water on the conductor side are considered. Because of non-uniformities and hydrostatic pressure of water, the membrane leaks water on the air side to varying extents. Thus, it becomes very difficult to reach an optimum balance between a constant rate of oxygen flow to the water side while holding water without leaks to the air side.

Accordingly, there is still a need to provide an improved electrode construction and electron-gas/collection-permeation systems therewith for use particularly in the field of MFCs.

### SUMMARY OF THE INVENTION

The present invention relates to a membrane for use as a packaging or in microbial fuel cells, said membrane comprising a first layer of a polymer having a high oxygen permeability and a second supporting layer made of a non-woven material or a woven material, both layers being dot laminated and/or pattern laminated together by using an adhesive.

### BRIEF DESCRIPTION OF THE DRAWINGS

FIG. 1 illustrates an embodiment of the state of the art.

FIG. 2 illustrates an embodiment of the membrane according to the present invention.

### DETAILED DESCRIPTION OF THE INVENTION

These and other features and advantages of the present invention will be more readily understood, by those of ordinary skill in the art, from a reading of the following detailed description. It is to be appreciated that those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.
Here and hereinafter the term “first layer of a polymer” can be used interchangeably with the term “first layer” or “polymer film”.
Here and hereinafter the term “second supporting layer” can be used interchangeably with the term “second layer”.
Here and hereinafter the term “current collector layer” can be used interchangeably with the term “conductive layer”.

For the purpose of the present invention “high oxygen permeability” shall mean an oxygen transmission rate of at least 10000 cm³/m².day.atm as measured according to ASTM F3985, at 23° C. and 50% relative humidity for a given material thickness.

Polymers that are known to have high oxygen permeability can be used to make a thin film and then laminate the film to an appropriate equivalent nonwoven material and then to a current collector layer (referred to later in this description) using an appropriate adhesive.

Additional important properties obtained by the invention is the durability of the substrate, such as UV stability and chemical stability. Polyolefin polymers have advantages regarding these properties compared to other polymers, such as polyesters. For long term operation in water, polyesters will have a pronounced tendency to hydrolyze and become chemically unstable, thus jeopardizing durable continuous function of the cell. The light weight and high strength properties of polyolefin nonwovens contribute to having a strong and self-sustainable membrane. An additional aspect is that the air permeability of the polyolefin nonwoven (second layer) must be higher than that of the polymer film (first layer) so as not to be the mass transfer limiting layer.

The laminate comprising, for example, Tyvek® dot laminated to PMP, and forming the membrane can also be used in any process involving passage of oxygen to microorganisms on the other side of the membrane, such as encountered with many fermentation broths.

Exemplary areas of use of the membrane according to the invention include:
air cathodes for MFC, for Microbial Electrodialysis, for water desalination and hydrogen gas production;
replacement of airlift reactors in biochemical reactors (preferably without conductor);
packaging that requires high or controlled oxygen flux (with or without a current collector).

In various embodiments, the invention is directed to a packaging system comprising a membrane as defined herein or a cathode for use in microbial fuel cells, or even a microbial fuel cell comprising at least one cathode as defined herein.

In one embodiment, the first layer may be a PMP (polymethylpentene). In another embodiment, the first layer of the membrane may have a thickness between 5 micrometers and 15 micrometers, preferably 10 micrometers. In yet another embodiment, the supporting layer may be made of flashspun high-density polyethylene fibers or melt spun polypropylene, or any of the polypropylene—SMS (spunbonded-meltblown-spunbonded) nonwoven materials or other wovens or nonwovens.

In yet another embodiment, the third layer may be made of glass fibers, or fibers of high temperature polymers, or polyphenylene sulphide, or graphitic carbon or composites thereof, optionally infused with carbon nanoparticles or nanotubes or fragments of carbon fibers of nano-size. In yet another embodiment the fibers may be electroplated prior to infusion of nanotubes. In yet another embodiment, aluminum or steel wires may be used as the raw fibers for the sheet formation. In yet another embodiment, the wires may have a diameter from 2 to 200 micrometers. In yet another embodiment, the third layer may be dot or pattern laminated with the first layer. In yet another embodiment the dot/pattern lamination may be made with a cyanoacrylate gel. In yet another embodiment the membrane may be dot-coated with carbon based powders, micropowders, nanotubes and carbon fiber fragment components, activated or not, and their combination.

In yet another embodiment, the dot coating may be a dot clustering according to a geometry which defines a coding functionality. In yet another embodiment the dot clustering may be a circle geometry containing various dot sizes and dot densities or triangular geometry or code bar dotting arrangements. In yet another embodiment the dot composition may comprise reactive tracers having an electrochemical activity. In yet another embodiment the reactive tracers may comprise metals, metal oxides, transition metals, metal clusters, organic compounds exhibiting electro-activity and organometallic complexes. In yet another embodiment the metals may comprise Ni (nickel), Pt (platinum), Pd (palladium), Co (cobalt), Mn (manganese) Cu (copper), Ag (silver), Al (aluminum), Fe (iron) and the metal oxides may comprise high adsorption area nickel oxide (NiO) and cobalt oxide (CoO). In yet another embodiment the organic compounds exhibiting electro-activity may comprise hydroquinones, PVP (polyvinylpyrrolidones), preferably hydrophobized PVP, exhibiting electro-activity such as oxidation-reduction electron transfer, metal-organic blends or chemical entities containing both. In yet another embodiment the organometallic complexes may comprise tetrakis-methoxypheny-porphyrinato cobalt (CoTMPP), cobalt, copper phthalocyanines, such as copper-butyl phthalocyanine.

### The Membrane of the Present Invention

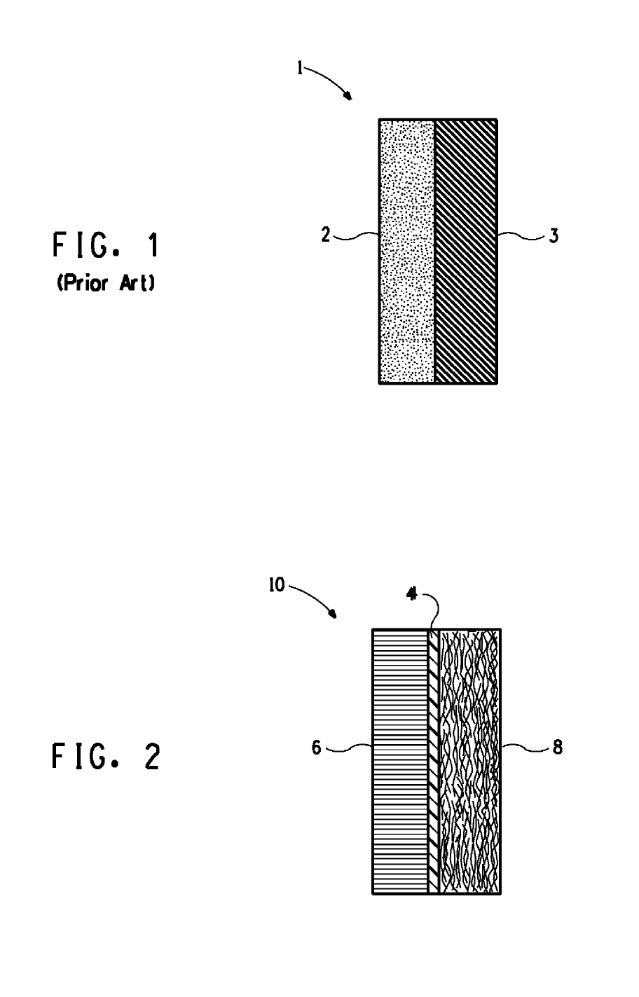

The membrane of the present invention is a semi permeable membrane which is water tight and oxygen permeable. FIG. 1 illustrates a cathode used in a fuel cell of the prior art, which comprises on the right (water) side a carbon black loaded conductor 1 or a steel brush and on the left (air) side a silicon coating layer 2. FIG. 2 illustrates in one embodiment of the membrane according to the invention, which comprises on the right (water) side a conductive third layer 8, a first layer 4 and second support layer 8 on the left (air) side.

### The First Layer

As mentioned above in the present description, one approach of the present invention is use polymers that are known to have high oxygen permeability to make a thin film. Typically, the first layer is made using cast or blow technology, if possible (not appropriate with silicon based materials), or any other equivalent technology. For example, PMP polymer grade TPX-MX002 from Mitsui Chemicals (Belgium) has proven to be appropriate and yields a very thin uniform film. Preferably, the thickness of the first layer (the polymer film), which is uniform throughout, is 8 to 16 micrometers, but for roll handling purposes 10 micrometers is an optimal choice, as it provides sufficient oxygen flow from the air to the water side, and resists a hydrostatic head of more than 3 m without water leaking to the air side.

### The Second Supporting Layer

A second supporting layer uses any self-supporting sheet, for example any fabric known in the fabric art, such as nonwoven, woven, knitted fabrics, membranes, microporous films, grids or a combination of two or more sheets such as for example SMS (spunbonded-meltblown-spunbonded) structures. Preferably, the sheet is a nonwoven or woven fabric comprising one or more synthetic (man-made) fibers or filaments. Natural fibers or filaments of the nonwoven or woven fabric can be chosen among cellulose, cotton, wool, silk, sisal, linen, flax, jute, kenaf, hemp, coconut, wheat, and rice and/or mixtures thereof. For materials sensitive to water, it is preferred to subject such material to a hydrophobic treatment such as ketene dimer treatment. Synthetic (man-made) fibers or filaments of the non-woven or woven fabric can be chosen among polyamides, polyaramides, polyesters, polyimides, polyolefins and/or hybrids and mixtures thereof. The second supporting layer is more preferably a nonwoven fabric. Examples of those nonwoven fabrics are polyethylene flash-spun fabrics, as commercially available, for example under the trade names Typar® or Tyvek® from E.I. du Pont de Nemours & Company, Wilmington Del. (DuPont) or a polypropylene SMS material.

The first layer can be cast or blown on to the supporting layer. Both layers are laminated together by using an adhesive. According to the present invention, lamination is not a full surface coverage lamination, but a discontinuous one over the surface, so that the adhesive does not prevent oxygen from passing. It is possible to laminate the layers together via points (dots) or patterns (such as screen patterns) as long as the process used does not prevent oxygen from passing through the membrane in accordance with the principles of the present invention. Such dots or patterns may be used in particular to improve the adhesion of the film to the supporting material. The adhesive used may be a cyanoacrylate gel (Kraft Kleber) from Henkel GmbH, Düsseldorf) or another equivalent adhesive material. The above described multilayer product can be produced in a roll to roll process and is economically 10 fold more desirable than any of the methods used today in production of MFCs.

### The Current Collector Layer:

When used in an MFC application as a cathode, the membrane may comprise a third layer as a conductive layer. Typically, such a layer is made of glass fibers on which a dense reticulated nanostructure is grown, which is formed by cross-linked nanotubes, such as the nanostructure described in “Applied Nanostructured Solutions LLC” (“ANS”). Other equivalent materials are possible in the frame of the present invention, such as fragments of carbon fibers of nano-size, for example, having a size of less than 300 nm. The carbon structure may also be functionalized or not (in order to improve its conductivity properties for example). Also, many other high temperature polymer fibers, having, for example, a melting point of at least 160°, such as fibers of Kevlar®, Nomex® (both available from DuPont) polyphenylene sulfide, as well as graphitic carbon or composites thereof may be used for forming the third layer. These fibers can be electroplated with reduced metal such as copper, aluminum, and other biocompatible metals and then on them a dense reticulated nanostructure is grown, which is formed by cross-linked nanotubes such as the nanostructure grown by ANS LLC cited above. Also, materials for forming the third layer can be chosen from the metals family, for example aluminum or steel wires with 2 to 200 micrometers diameter, on which a dense reticulated nanostructure is grown, which is formed by cross-linked nanotubes, such as the nanostructure grown by ANS LLC cited above. All fibers and wires cited herein can be formed into various structures (woven, nonwoven, dry laid or spun laced) thereby creating a three dimensional sheet of a conductive substrate with metal-like conductivity. These formed sheets offer a very high surface area for bacterial growth and development of biofilm, also they perform an optimal current collection, with very low ohmic losses. Examples of structures using infused carbon nanotubes are given in the following publications: US 2011/0216476, US 2011/0186775, US 2011/0180478, US 2011/0124483, US 2011/0304964, US 2011/0242731 all to Assignee Applied Nanostructured Solutions LLC, and US 2010/0258111, US 2010/0178825 both to Assignee Lockheed Martin Corporation.

### Assembly of the Semi Permeable Membrane of the Present Invention and the Current Collector for an Air Cathode:

For practical purposes in the application, the air cathode is an essential and costly element of water treatment technology. Some configurations are reported, e.g., in US patent application 2011/0229742. The most straightforward are square or rectangular panels disposed vertically and tightened to the metal structure of the container at their edges, or welded tubes disposed as in the case of a tube and shell heat exchanger.

The semi-permeable membrane can be laminated to the current collector in the tube configuration. This lamination must be carried out in the same manner as in the assembly of the semi-permeable membrane and the nonwoven described earlier, using dot/pattern lamination or equivalent processes by using an adhesive, such as with the cyanoacrylate adhesive from Henkel GmbH Düsseldorf or similar adhesives. Alternatively one may choose to not laminate, but only put the current collector side-by-side with the semi-permeable membrane. The latter choice offers the advantages of reducing maintenance costs as one of the elements can always be reused.

As already mentioned above, in another embodiment, the membrane according to the present invention may be used as a cover for perishable products, such as food. When the current collector is not applied, the laminate comprising, for example, Tyvek dot laminated to PMP as described above forming the membrane, may be used in any process involving passage of oxygen to microorganisms on the other side of the membrane, such as encountered in many fermentation broths. In this form the composite membrane can be used as an active packaging in applications such as oxygen scavenging to preserve shelf life of many foodstuffs. In this form also, it can be used to liberate excess CO₂ from a yeast package. Experience shows that in this case, the amount of CO₂ that can be exchanged is three times that of oxygen.

However, the membranes used in active packaging applications may also comprise an electrically conductive layer, as the one described above for the MFC application, in this case for electrostatic or other purposes. In such applications, the description made above for MFC applies correspondingly for the principle of construction of the membrane. Furthermore, a metallic layer may be used, for example, for identification coding and expiration date anticipation. In the case of coding, one may use specific shape in the metallic layer to code some information (recognition of the membrane, identification of use or goods etc). The shape may be personalized by presence/absence of metallic layer, or different thicknesses of layers and any other suitable construction that allows a coding to be defined. Also, the presence of a metallic layer could be used for expiration date tracking in which case, for example, the level of oxidation of the metallic layer may be used as a reference. Determining the change in its electrical properties would then allow tracking its “age” with respect to a predetermined expiration date. The expiration date may also not be an absolute value but a relative value, the membrane being considered suitable for use as long as the electrical properties of its metallic layer are within a certain range.

The outer layer of the membrane assembly is preferably dot-coated with carbon based powders, micro-powders, nanotubes and carbon fibre fragment components, activated or not, and their combination therewith. It has been found beneficial to further engineer the dotting patterns to enable the reading of codes encrypted in the dot composition and/or readable according to the dots positioning respective to one another. The conductive nature of carbon matter makes the decoding simpler.

For example, dot clustering according to circle geometry containing various dot sizes and dot densities can be used for material identification per se, while triangular geometry may be used for safety and security coding aspects. Code bar dotting arrangements can also be added. An additional encoding-like feature was found deriving from the main application domain of the present invention. The membrane electrode assembly was conceived in a way that oxygen and carbon dioxide can be selectively transported through the assembly allowing for and maximizing the electron current collection. It is well recognized that oxygen and carbon dioxide are determining factors in the ageing and freshness preservation of certain goods, such as food and medical formulations. It is therefore important to be able to trace back the exposure time of those goods to those gas entities. It has been found especially relevant to wrap those goods in a selected packaging material such as the proposed membrane assembly.

For the main application, the knowledge of the flux of those gasses is also valuable information to determine any ageing effect or simply to make recommendations regarding the best use of the membrane assembly or of the electrode assembly all together, based on a good knowledge of the occurred operation time. Furthermore, it was found that the insertion of reactive tracers into the dot composition, by any means known in the art, is an efficient way to track back ageing aspects and expiration dates as a function of the flux of oxygen and carbon dioxide which went through the membrane assembly being used as an electrode component or a packaging medium. Metals, metal oxides, transition metals, metal clusters were found efficient for the reactive tracing purpose described above. Preferably, Ni (nickel), Pt (platinum), Pd (palladium), Co (cobalt), Mn (manganese) Cu (copper), Ag (silver), Al (aluminium), Fe (iron), were especially found suitable for that purpose in various chemical forms. Both carbon dioxide and oxygen tracing performed well using those entities and related chemical families.

High adsorption area nickel oxide (NiO) and cobalt oxide (CoO) used as reactive tracers were obtained from thermal decomposition of nickel hydroxide (preheating at 105° C. for a few hours and then for more than 12 hours at 200° C.), or of cobalt carbonate under similar conditions but higher final heating conditions such as 250° C. under controlled atmosphere.

Organic compounds such as hydroquinones, PVP (polyvinylpyrrolidones), preferably hydrophobized PVP, exhibiting electro-activity, typically but not limited to oxidation-reduction electron transfer, as well as metal-organic blends or chemical entities containing both, were also found suitable. Diverse conducting polymer-based materials, used as electronic probes, have been found suitable by benefiting from the conductive nature of the polymer. More specifically, one may utilize the chemical polymerization of pyrrole under various controlled conditions to produce thin conducting films. By using this methodology, a variety of polymer films that have distinctly different electrical resistance responses to various gasses and vapours are obtained.

Organometallic complexes, such as, tetrakis-methoxypheny-porphyrinato cobalt (CoTMPP),cobalt and copper phthalocyanines,copper-butyl phthalocyanine obtained from Aldrich are also suitable reactive tracers. Microporous materials and more specifically metal organic frameworks are suitable to selectively separate the gasses of interest from the vapour flux allowing for more reactivity of those separated matters with the reactive electro-active tracers.

Especially the conductive nature of the dots made essentially of carbon matter and, metal or organic or metal-organic and combination thereof, tracers, having electrochemical activity were found especially suitable to provide measurement of the oxygen and carbon dioxide exposure using conductivity and or resistivity evolution of the selected dot area.

Generally the oxygen and carbon dioxide induced metal conversion to various oxides led to an increase or a decrease of the conductivity of more than 5% versus initial state, allowing, given that a calibration was made, for the dating of the goods being wrapped in the membrane or allowing for the accurate measurement of the operation time of the membrane and of the electrode therewith.

The invention will be further described by reference to the following Examples.

### EXAMPLES

### Example 1

Three resins (first layer) have been cast in the thicknesses shown in Table 1 below and were dot laminated to Tyvek® fabric (from DuPont) having high air permeability (second supporting layer), using a cyanoacrylate adhesive from Henkel (Kraft Kleber). Oxygen transmission rates (OTR) have been determined using method ASTM F3985. Water (hydrostatic) head has been measured using method DIN EN 20811, and was determined to be higher than 4.5 m for all three laminates, indicating there will be no water leakage in the real application as envisaged in the present application.

TABLE 1

| | | OTR (ASTM F3985: |
|---|---|---|
| | | 23° C.; 50% RH) |
| Resin Type | Thickness (μm) | (cm³/m² · day · bar) |
| 1.1 PMP M002 | 8.2 | >60000 |
| (Mitsui Chemicals) | | |
| 1.2 Elvalloy AC 3427 | 12.3 | >60000 |
| (DuPont) | | |
| 1.3 Exact ® 9061 | 13.9 | >60000 |
| (ExxonMobil Chemical) | | |

MP stands for polymethylpentene, an olefinic polymer and M002 is the Mitsui's code for the grade.
Elvaloy ® AC 3427 being a copolymer of ethylene and butyl acrylate available from DuPont de Nemours, Geneva.
Exact ® 9061 is a an ethylene butene copolymer available from ExxonMobil Chemical, Luxembourg.
Since the laminates have a high transmission rate of oxygen and in order not to endanger the detector, the oxygen permeability was also determined by a manometric method (DIN 53380-2). There is a differential pressure of 1 bar between the two sides of the laminates. The results from these methods indicate a flow of oxygen for all 3 resins of >3.000.000 cm³/m² · day · bar.

In real use (as described below) with air on one side and water containing bacteria on the other side, the mass transfer is driven by concentration difference about 21% on one side and 0% on the water side, since the bacteria consume oxygen as soon as it gets there. The total transmission rate for the PMP laminate, the highest of the three laminates was found to be 20200 cm³/m².day.bar. The resistance to mass transfer is by another mechanism as opposed to pressure driven mass transfer.

### Example 2

The Tyvek® fabric as used in example 1 was extrusion coated with resin 1.3. An additional sample was prepared with an UV—curable PDMS (polydimethylesiloxane) on Tyvek®, known to have the highest oxygen transmission rate. In order for the latter to have a good resistance to water leakage, an amount between 8 and 15 g/m² was needed. While extrusion coating and the polydimethylesiloxane samples were very easy to produce in one step, their oxygen transfer rate (OTR) in the real use was only a fraction of the PMP laminate of Example 1 (OTR), which was produced by casting the resin first and dot laminating it to Tyvek® afterwards.

TABLE 2

| Sample type | OTR in real use | Cost appreciation |
|---|---|---|
| 1.1 Tyvek ® - PMP | 20200 | Medium |
| laminate | | |
| 2.1 Exact 9061 extr. | 9085 | Low |
| Coated Tyvek ® | | |
| 2.2 PDMS coated | 10706 | High. |
| Tyvek ® | | |

“Real use” in the table means during the fuel cell operation in which the oxygen gradient is constant at 21%, and the mass transfer being carried from an atmospheric air side through the membrane to the water side. The differences in OTR's can be explained with non-uniformities of the coated products on a porous structure like Tyvek ®.

### Example 3

In one embodiment of the three layer composite for MFC, glass fibers were infused with carbon nanotubes and made into a flexible sheet by weaving the resulting fibers. The flexible conductive sheet had a very high surface area (96% void fraction space) and resulted in a resistivity of around 0.05-0.08 Ohms (1250-2000 Siemens/m) measured by the four point method. This composite used in an air cathode configuration in a one liter laboratory bio-electrochemical system with an anode area of 0.1 m² and a grown biofilm of Shewanella with a waste water BOD of 7500 mg/L. This set up with small electrode spacing resulted in a current density between 28 and 40 A/m².

What we claim is:

1. A membrane comprising: a first layer of a polymer having a high oxygen permeability, and a second supporting layer made of a woven or a non-woven material, wherein both layers are dot laminated or pattern laminated together by using an adhesive.

2. The membrane of claim 1, wherein the polymer of the first layer is polymethylpentene.

3. The membrane of claim 1, wherein said supporting layer is selected from the group consisting of polyethylene nonwoven, polypropylene nonwoven, and polypropylene spunbonded-meltblown-spunbonded nonwoven.

4. The membrane of claim 1, wherein said supporting layer is selected from the group consisting of flashspun high-density polyethylene fibers and melt spun polypropylene fibers.

5. The membrane of claim 1, further comprising a third layer as a current collector layer and made of fibers selected from the group consisting of glass fibers, fibers of high temperature polymers, polyphenylene sulfide and combinations thereof, graphitic carbon and composites thereof.

6. The membrane of claim 5, wherein said third layer is made of fibers, infused with materials selected from the group consisting of carbon nanoparticles, carbon nanotubes, fragments of carbon fibers of nano-size and combinations of said fibers.

7. The membrane of claim 6, wherein said fibers and said graphitic carbon or composites thereof are electroplated prior to infusion of nanotubes.

8. The membrane of claim 5, wherein said third layer is dot laminated or pattern laminated with said first layer.

9. The membrane of claim 1, wherein the dot lamination or the pattern lamination is made with an cyanoacrylate gel adhesive.

10. The membrane of claim 1, wherein it is discontinuously coated with a coating composition selected from the group consisting of carbon based powders, micropowders, nanotubes and carbon fiber fragment components and with combinations thereof.

11. The membrane of claim 10, wherein the coating is a dot clustering according to a geometry which defines a coding functionality and is selected from the group consisting of circle geometry containing various dot sizes and dot densities, triangular geometry and code bar dotting arrangements.

12. The membrane of claim 10, wherein the coating composition comprises reactive tracers having an electrochemical activity and are selected from the group consisting of metals, metal oxides, transition metals, metal clusters, organic compounds exhibiting electro-activity, organometallic complexes and combinations thereof.

13. The membrane of claim 12, wherein the metals are selected from the group consisting of nickel, platinum, palladium, cobalt, manganese, copper, silver, aluminium and iron and wherein the metal oxides are selected from the group consisting of high adsorption area nickel oxide and cobalt oxide.

14. The membrane of claim 12, wherein the organic compounds exhibiting electro-activity comprise polymers exhibiting electro-activity such as oxidation-reduction electron transfer, selected from the group consisting of hydroquinones, polyvinylpyrrolidones, hydrophobized polyvinylpyrrolidones, and combinations thereof, metal-organic blends and combinations of said polymers exhibiting electro-activity and metal-organic blends.

15. The membrane of claim 12, wherein the organometallic complexes are selected from the group consisting of tetrakis-methoxyphenyl-porphyrinato cobalt, cobalt phthalocyanines, copper phthalocyanines, copper butyl phthalocyanine, and combinations thereof.
